(19) United States
(12) Patent Application Publication
(10) Pub. No.: US 2017/0359670 A1
(43) Pub. Date: Dec. 14, 2017

(54) NOVEL METHOD OF IMPROVING THE RESTITUTION OF STEREOPHONIC MODULATIONS IN AUTOMOBILES

(71) Applicant: Claude CARPENTIER, Maisons Laffitte (FR)

(72) Inventor: Claude CARPENTIER, Maisons Laffitte (FR)

(21) Appl. No.: 15/523,946

(22) PCT Filed: Nov. 5, 2015
(86) PCT No.: PCT/FR2015/000203

§ 371 Date: May 3, 2017

(30) Foreign Application Priority Data
Nov. 7, 2014 (FR) 14 02534

(51) Int. Cl. H04S 7/00; H04S 1/00

(52) U.S. Cl. CPC H04S 7/303; H04S 1/007; G10H 2240/131

(57) ABSTRACT

New method for improving the reproduction of stereophonic modulations in cars.

According to this method, in first step the level distortion in uncorrelated isobar mode is canceled first by means of the balance adjustment, in a second stage the center of the sound image is positioned at the center of the sound scene in the isobaric correlated mode in delaying the modulation feeding the loudspeaker closest to the conductor and in a third stage by canceling the stereophonic phase distortion in the isobaric mode correlated by means of a phase equalizer.

New method for improving the reproduction of stereophonic modulations in cars.

All passenger vehicles manufactured by car manufacturers are equipped with a speaker system designed to reproduce stereophonic modulations

Stereophonic modulation is composed of two electrical signals called left and right channels for powering two loudspeakers through two power amplifiers.

The stereophonic method makes it possible to obtain a continuous and homogeneous sound image from two loudspeakers provided that the listener is equidistant from these two loudspeakers.

But it is impossible for two listeners sitting side by side in a car to be located at equal distances from two loudspeakers diffusing the left and right channels.

in cars, the difference in the distance between. the speakers and the listeners causes distortions of levels and phases which deeply disturbs the reproduction of the stereophonic modulations.

In stereophony, we call the sound field all the points of space from which the sound seems to be, and sound image the distribution of the sound objects in the sound field. The center of the sound image must be reproduced in the center of the sound field.

The difference in distance between the speakers and the listeners unbalances the sound field and deteriorates the sound image. The center of the sound image is no longer in the center of the sound image but close to the nearest speaker.

Techniques to improve stereophonic reproduction in cars fall into two categories. On the one hand, mono-stereophonic techniques that aim to improve reproduction for a listener in general the driver without worrying about the consequences for the other listener and on the other hand the bi-stereophonic techniques that aim to improve the reproduction simultaneously for the two listeners sitting side by side in the car.

The mono-stereophony is justified in that it is much easier to implement than the bi-stereophony and as the driver is often alone in his car, it may be considered advantageous to provide a mono-stereophonic setting which gives him better quality of reproduction when he is alone in his car.

The present invention is a mono-stereophonic technique. Our tests consisted of improving the reproduction for the driver sitting in the front left of the car.

In the following, “stereophonic phase” corresponds to the electrical phase difference between the left and right channels, and “acoustic stereophonic phase” means the acoustic phase difference between the left and right channels at the listening point.

In the following, <<phase distorsion>> a corresponds to the acoustic phase difference between the left and right channels at the listening point when the stereophonic phase is zero.

In free field, when the listener is at equal distance from the left and right speakers, the phase distortion is zero.

In stereophony there are two main modes. On the one hand, the uncorrelated isobar mode in which the level of the channels is identical but their phase is not correlated. A modulation generating a choir uniformly distributed over the entire width of the sound image is in uncorrelated isobar mode. On the other hand, the correlated isobar mode in which the two channels are in phase and of identical levels, that is to say they deliver the same signal

A modulation generating a singer alone in the middle of the sound image is in isobar correlated mode.

When a stereophonic equipment works well, the listener perceives in uncorrelated isobar mode the two ends of the sound field with the same intensity and in isobaric correlated mode the center of the sound image is reproduced in the center of the sound field with a good correlation.

The center of the sound image is generated by the two loudspeakers broadcasting the same signal. When there is phase distortion, the center of the sound image is not in the same position at all frequencies and therefore the center of the sound image is poorly correlated.

In a car equipped with a basic installation on the one hand in uncorrelated isobaric mode the listener perceives the closest end of the sound field with more intensity than the farthest end and on the other hand in isobaric correlated mode the center of the sound image is not at the center of the sound field and moreover it is badly correlated.

The conventional technique of mono-stereophony consists first of all in adjusting the level balance between the channels so that the favored listener perceives the two ends of the sound field with the same intensity in uncorrelated isobaric mode and then, in delaying the signal feeding the loudspeaker closest to the listener to create an interaural delay causing the center of the sound image to move to the farthest loudspeaker.

This technique effectively makes it possible to position the center of the sound image at the center of the sound field but it has the disadvantage of not mastering the acoustic stereophonic phase, hence a phase distortion causing a lack of correlation in the center of the sound image.

With the French Pat. No. 2,985,143 we have proposed a method consisting in a first step of canceling the stereophonic phase distortion, which generates a center of the sound image in front of the listener and then in a second step moving the center of the sound image to the center of the sound field by acting on the coefficients of the stereophonic matrix, that is to say on the percentages of sum and difference signals in the left and right channels.

This method makes it possible to obtain the center of the sound image at the center of the sound field with a good correlation but at the cost of a double manipulation of the phase and the stereophonic matrix.

The present invention is a method for obtaining in a simpler manner the center of the sound image at the center of the sound field with a good correlation.

The method according to the present invention consists, as in the conventional method, in a first step of adjusting the level balance between the two channels so that the favored listener perceives in uncorrelated isobaric mode the two ends of the sound field with the same intensity and then in a second image, delaying the signal from the nearest loudspeaker in order to obtain an interaural delay which positions the center of the sound image in the desired position, the innovation consisting in a third step canceling the residual phase distortion.

Indeed, we have discovered by chance and it has been unexpected and remarkably interesting for us that the operation of correcting the stereophonic phase necessary to cancel the phase distortion does not change the position of the center of the sound image which makes this process very easy to implement while providing an excellent result.

It is commonly accepted that the effects of phase distortion are perceptible by the human ears up to about 1500 Hz, In our tests we have canceled the phase distortion in the 30 Hz-1600 Hz band.

The value of the phase correction to be applied to the left channel to cancel the phase distortion at a given frequency is the complement to zero of the phase distortion as defined above.

For example if at 500 Hz the phase distortion at the left listening point is [φ_{G}-φ_{D}]_{G}=30° it is canceled by shifting the phase of the left channel at this frequency of −30°.

For our tests, we first measured the phase distortion after applying the time shifting using the SPECTRALAB v: 4.32.14 software, which has a tool for measuring the phase difference between the left and right signals at the entrance of the sound card.

We installed a microphone at the listening position and then we introduced a pink noise to the input of the amplifier feeding the left speaker and we supply the left channel of the sound card with the signal coming from the microphone and the right channel with pink noise entering into the amplifier.

SPECTRALAB provided us the phase difference for each third of octave between 30 Hz and 1600 Hz that we have transferred into EXCEL.

Then we introduced pink noise to the input of the amplifier feeding the right, speaker and SPECTRALAB provided us the phase difference [φ_{D}-φ_{BR}]_{G} for each third octave band between 30 Hz and 1600 Hz that we have reported into EXCEL.

By doing in EXCEL the difference between the two measurements we get: [φ_{G}-φ_{BR}]_{G}−[φ_{D}-φ_{BR}]_{G}=[φ_{G}-φ_{D}]_{G} Ie the phase distortion.

Is To correct the electrical stereophonic phase, we used the “GRAPHIC PHASE SHIFTER” tool of the Cool Edit Pro 2.1 software which allows to correct the phase of a signal of any value at any frequency with absolute precision.

We have applied to the left channel for each third octave a phase shift equal to the complement to zero of the value [φ_{G}-φ_{D}]_{G} given by EXCEL.

This manipulation did. not produce the desired result. After investigations we found a bug in the GRAPHIC PHASE SHIFTER tool of COOL EDIT PRO 2.1. Indeed, it applies a phase correction of the inverse sign to the requested correction.

We have thus reversed the sign of the phase correction and this time we have obtained the cancellation of the phase distortion and observed a very significant improvement of the correlation of the center of the sound image.

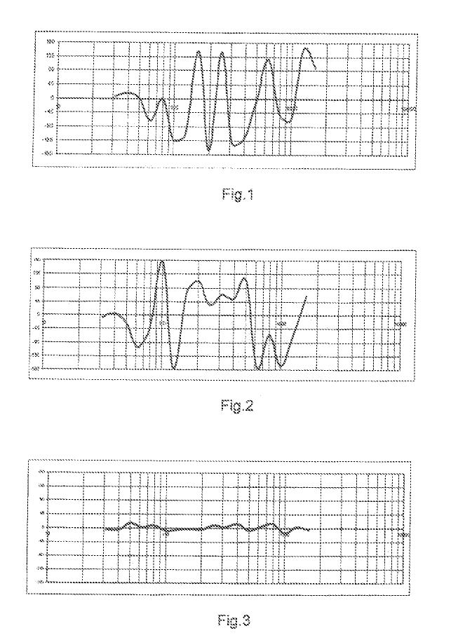

The curve in FIG. 1 is the original phase distortion at the left listening point [φ_{G}-φ_{D}]_{G} in our test vehicle.

This curve is absolutely catastrophic, it reflects the quality of reproduction of uncorrected original installations.

The curve of FIG. 2 is the residual phase distortion in this same vehicle after application of a delay of 1.31 ms on the left channel. There is some improvement but the residual phase distortion is still very important.

The curve of FIG. 3 is the residual phase distortion after application of the phase distortion cancellation procedure.

This result is quite remarkable. It shows that the acoustic phase is a linear function of the electrical phase, which was not obvious. Given the complexity of sound. reproduction in a confined space of small dimensions we could have had ruptures of linearity.

For industrial applications, the present invention can take several forms.

For applications in vehicles, for original equipments or aftermarket, it will be necessary for those skilled in the art to implement in the car stereo reproduction system a real-time software capable of modifying the stereophonic modulation in accordance with the method according to the present invention After the introduction of the vehicle specific parameters.

Since the method according to the present invention is pure signal processing without modification of the installation in the car, the desired result can be obtained with a conventional installation by modifying the audio file.

In Cool Edit Pro the modification of the audio file according to the present invention is done in 3 steps.

It would be advantageous to create a software allowing the modification in a single step which could be enhanced by a level equalization, which would make it possible to obtain a quality of reproduction capable of satisfying the most demanding amateurs who could thus obtaining versions of their preferred discs adapted to their vehicle.

This software would look for the setting of the modification on a server indicating the model of the vehicle and its audio equipment.

A variant would be that an online music sales site like ITUNE enriches its offer by proposing corrected versions adapted to each vehicle.

1. A method of improving the reproduction of a stereophonic modulation at a. point of listening of an automobile, characterized in that the ratio of the levels of the left and right channels is first adjusted so that the listener perceives In uncorrelated isobaric mode the two ends of the sound image with the same intensity, that in a second step a delay is applied to the signal feeding the loudspeaker closest to the listener so that the listener perceives in isobaric correlated mode the center of the sound image in the desired position and in a third step canceling the phase distortion for the listening position.

2. A stereophonic reproduction device equipped with signal processing means and characterized in that the processing means are configured to allow the implementation of the adjustment method described in claim 1.

3. A motor vehicle equipped with a device according to claim 2.

4. A software for processing stereophonic modulations, characterized in that it is capable, in a single operation, of modifying a stereophonic modulation in accordance with the method according to claim 1 and in that it is arranged to fetch on a server the the vehicle's tuning parameters according to the model and type of audio equipment.

5. A music server equipped with software according to claim 4 and further comprising in memory the correction parameters for each vehicle model and arranged to provide pieces of music corrected according to the vehicle model indicated by the customer.
